(19) United States
(12) Patent Application Publication
(10) Pub. No.: US 2013/0133322 A1
(43) Pub. Date: May 30, 2013

(54) COOLING SYSTEM FOR AN EXHAUST PIPE OF A VEHICLE

(71) Applicant: Kwang Yang Motor Co., Ltd., Kaohsiung (TW)

(72) Inventors: Chien-Ping TSENG, Kaohsiung City (TW); Wen-Ming SU, Kaohsiung City (TW)

(73) Assignee: KWANG YANG MOTOR CO., LTD., Kaohsiung (TW)

(21) Appl. No.: 13/685,451

(22) Filed: Nov. 26, 2012

(30) Foreign Application Priority Data
Nov. 29, 2011 (TW) 100143694

(51) Int. Cl. F02B 41/00

(52) U.S. Cl. CPC F02B 41/00
USPC 60/614

(57) ABSTRACT

A cooling system for an exhaust pipe of a vehicle has an engine, an exhaust discharging device connected to the engine, a generator driven by the engine and a cooling guide device. Even when the vehicle is idle, the cooling guide device still guides cool air from the generator to the exhaust discharging device to dissipate heat of the exhaust discharging device. Therefore, the heat of the exhaust discharging device is efficiently dissipated.

The current application claims a foreign priority to the patent application of Taiwan No. 100143694 filed on Nov. 29, 2011.

### BACKGROUND OF THE INVENTION

1. Field of the Invention

The present invention relates to a cooling system, especially to a cooling system for an exhaust pipe of a vehicle.

2. Description of the Prior Art(s)

An engine of a vehicle has an exhaust pipe that expels high temperature exhaust air from the engine. Since the temperature of the exhaust air is as high as 200 degree Celsius to 300 degree Celsius, when the exhaust air flows through the exhaust pipe to be expelled out of the vehicle, temperature of the exhaust pipe increases accordingly. If heat of the exhaust pipe is not dissipated timely to lower the temperature of the exhaust pipe, lifetimes of components of the vehicle that are disposed in the vehicle and adjacent to an inner portion of the exhaust pipe are shortened and an outer portion of the exhaust pipe that protrudes out of the vehicle also burns or easily injures people around the outer portion of the exhaust pipe.

A conventional way to dissipate the heat of the exhaust pipe of the vehicle is to dissipate the heat via air flowing around the exhaust pipe when the vehicle is driven forward. The faster the vehicle, the higher the relative speed between the air and the exhaust pipe, and the better the heat dissipating efficiency. However, when the vehicle stops moving and the engine still operates constantly, the air around the exhaust pipe is unable to dissipate the heat of the exhaust pipe efficiently. Therefore, the temperature of the exhaust pipe of the vehicle rises, the exhaust pipe remains at high temperature or is overheated.

To overcome the shortcomings, the present invention provides a cooling system for an exhaust pipe of a vehicle to mitigate or obviate the aforementioned problems.

### SUMMARY OF THE INVENTION

The main objective of the present invention is to provide a cooling system for an exhaust pipe of a vehicle. The cooling system has an engine, an exhaust discharging device, a generator and a cooling guide device. The exhaust discharging device is connected to the engine. The generator has a housing, a rotor and a fan. The rotor is mounted in the housing, and is connected to and driven by the engine. The fan is mounted in the housing, is connected to the rotor and synchronously rotates with the rotor. The cooling guide device is connected to the housing of the generator and has a guide tube. The guide tube has a proximal end connected to the housing and communicating with the housing, and a distal end corresponding to the exhaust discharging device. The fan forms an air current to blow the exhaust discharging device.

The engine drives the generator to generate electricity and to supply the electricity to electric equipments on the vehicle. The generator drives the fan to draw cool air into the generator. Then the cool air flows through the generator and the guide tube and is discharged to the exhaust discharging device. Thus, the cool air becomes an air current to blow the exhaust discharging device. Even when the vehicle is idle, the cool air still lowers temperature of the exhaust discharging device efficiently. Consequently, components of the vehicle that are disposed in the vehicle and adjacent to the exhaust discharging device are not overheated and can have normal lifetimes. Temperature of the exhaust air that is expelled from the exhaust discharging device is also efficiently lowered.

Other objectives, advantages and novel features of the invention will become more apparent from the following detailed description when taken in conjunction with the accompanying drawings.

### BRIEF DESCRIPTION OF THE DRAWINGS

FIG. 1 is a top view of a cooling system for an exhaust pipe of a vehicle in accordance with the present invention;

FIG. 2 is a perspective view of the cooling system in FIG. 1;

FIG. 3 is a side view of a generator of the cooling system in FIG. 1; and

FIG. 4 is a cross-sectional side view of the generator and an engine of the cooling system in FIG. 1;

FIG. 5 is a perspective view of a fan of the generator in FIG. 3;

FIG. 6 is another top view of the cooling system in FIG. 1; and

FIG. 7 is a top view of another embodiment of a cooling system for an exhaust pipe of a vehicle in accordance with the present invention.

### DETAILED DESCRIPTION OF THE PREFERRED EMBODIMENTS

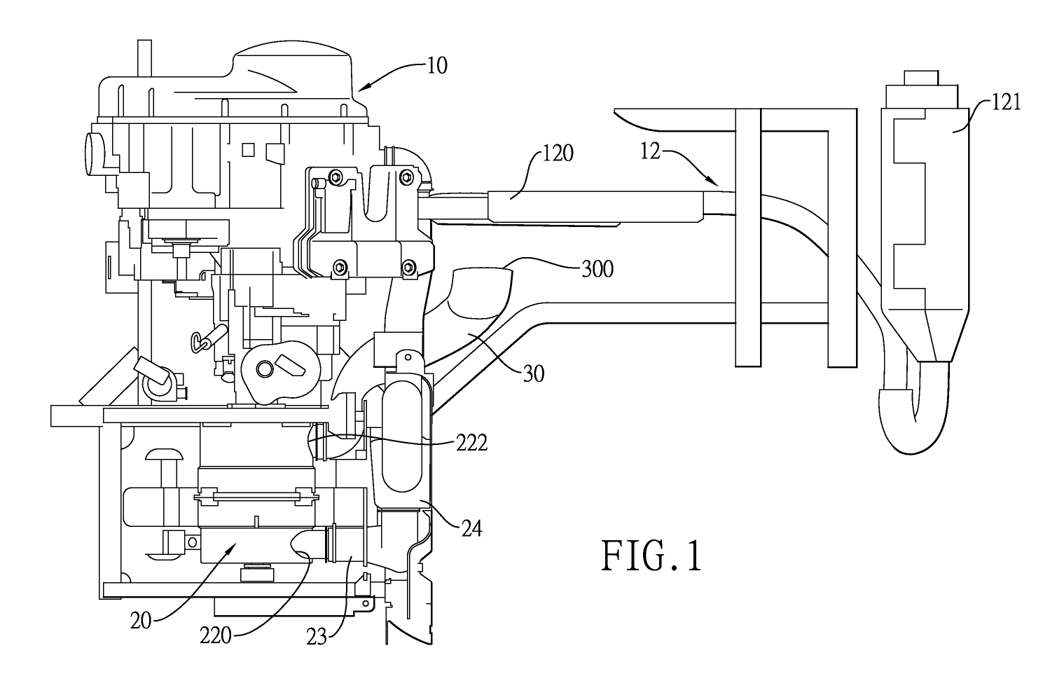

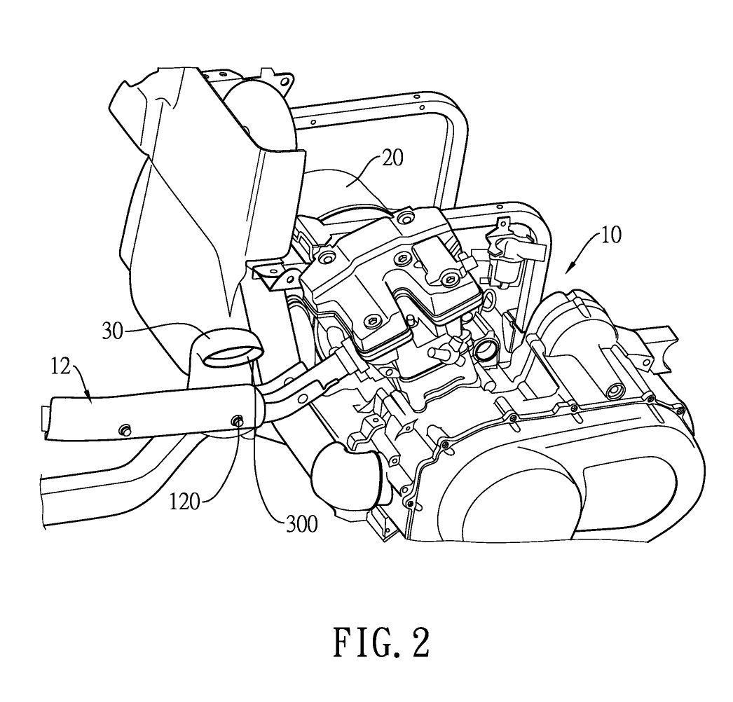

With reference to FIGS. 1 and 2, a cooling system for an exhaust pipe of a vehicle in accordance with the present invention comprises an engine 10, an exhaust discharging device 12, a generator 20 and a cooling guide device.

The engine 10 is conventional. The exhaust discharging device 12 is a conventional exhaust pipe of a cylinder, is connected to the engine 10 and has a front portion 120 of an exhaust pipe and a rear portion 121 of the exhaust pipe. The front portion 120 of the exhaust pipe of the exhaust discharging device 12 is connected to the engine 10. The rear portion 121 of the exhaust pipe of the exhaust discharging device 12 extends toward a rear of the vehicle and is connected to a muffler. Combustion of a fuel occurs in the engine 10 to output mechanical power. Exhaust air that is heated by the burning fuel flows through and is filtered by the exhaust discharging device 12 and is discharged out of the vehicle through the exhaust discharging device 12.

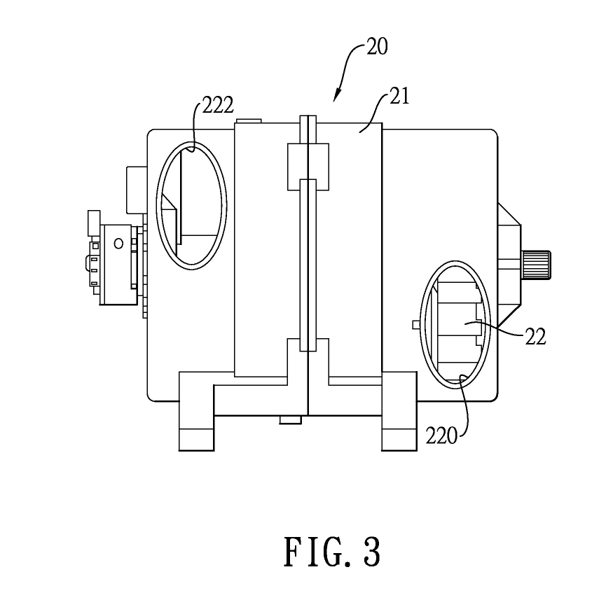

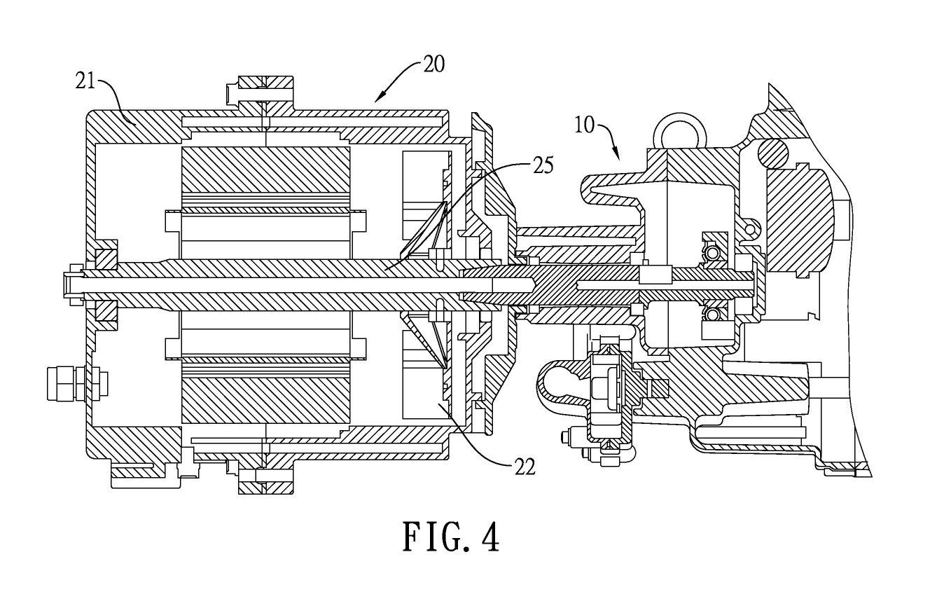

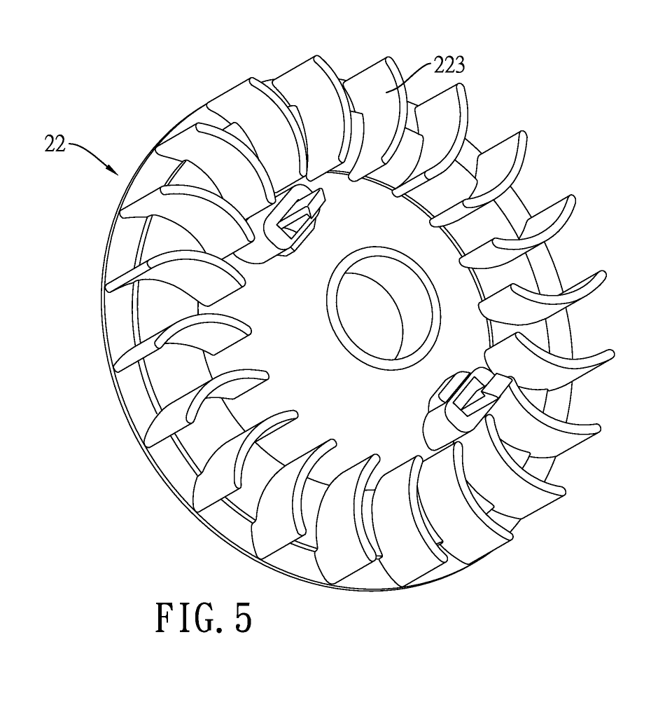

With further reference to FIGS. 3 and 4, the generator 20 is disposed beside the engine 10 and has a housing 21, a rotor 25, a fan 22, an inlet pipe 23 and a wind collection cover 24. The housing 21 is hollow and has an outlet 222 and an inlet 220. The outlet 222 of the housing 21 is formed through the housing 21. The inlet 220 of the housing 21 is formed through the housing 21 and is disposed more distant from the engine 10 than the outlet 222 of the housing 21. The rotor 25 is mounted in the housing 21, and is connected to and driven by the engine 10. The fan 22 is mounted in the housing 21, corresponds to the inlet 220 of the housing 21, is connected to the rotor 25, synchronously rotates with the rotor 25 and has multiple blades 223. The blades 223 of the fan 22 are radially arranged. With further reference to FIG. 5, each blade 223 may be curved, Otherwise, each blade may be twisted and inclined. When the fan 22 rotates, air around the housing 21 is drawn into the housing 21 via the inlet 220 of the housing 21 and is discharged out of the housing 21 through the outlet 222 of the housing 21. The inlet pipe 23 is connected to the housing 21 and corresponds to the inlet 220 of the housing 21. The wind collection cover 24 is connected to the inlet pipe 23 and has an inlet.

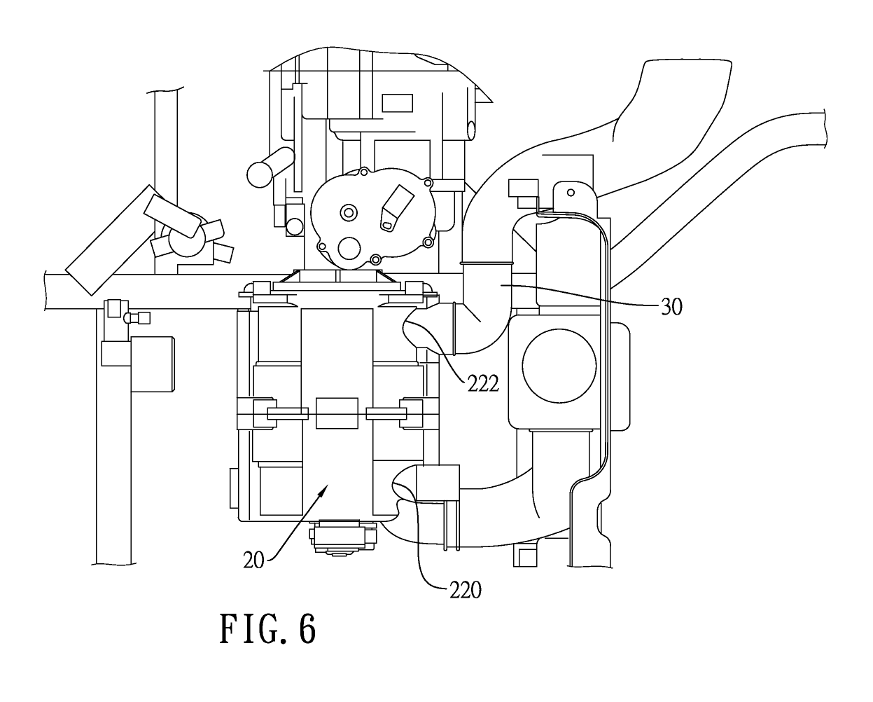

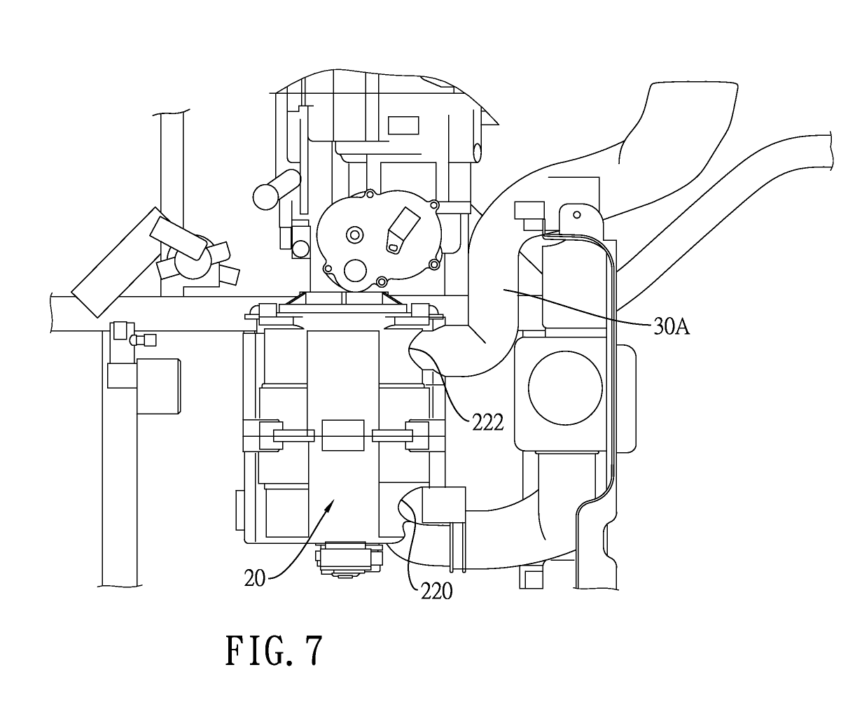

With further reference to FIGS. 6 and 7, the cooling guide device is connected to the housing 21 of the generator 20 and has a guide tube 30, 30A. As shown in FIG. 6, the guide tube 30 may be an orthogonal elbow tube. Otherwise, as shown in FIG. 7, the guide tube 30A may be integral and curved. The guide tube 30, 30A has a proximal end and a distal end. The proximal end of the guide tube 30, 30A is connected to the housing 21, and corresponds to and communicates with the outlet 222 of the housing 21. The distal end of the guide tube 30, 30A corresponds to the front portion 120 of the exhaust pipe of the exhaust discharging device 12.

When the vehicle is operated, the engine 10 drives the generator 20 to generate electricity and to supply the electricity to electric equipments on the vehicle. Moreover, the generator 20 drives the fan 22 to draw cool air into the generator 20 via the inlet 220. Then the cool air flows through the outlet 222 and the guide tube 30, 30A and is discharged to the front portion 120 of the exhaust pipe of the exhaust discharging device 12. Thus, the cool air becomes an air current to blow the front portion 120 of the exhaust pipe of the exhaust discharging device 12. Even when the vehicle is idle, the cool air still lowers temperature of the exhaust discharging device 12 efficiently. Consequently, components of the vehicle that are disposed in the vehicle and adjacent to the front portion 120 of the exhaust pipe of the exhaust discharging device 12 are not overheated and can have normal lifetimes, and temperature of the exhaust air that is expelled from the rear portion 121 of the exhaust pipe of the exhaust discharging device 12 is also efficiently lowered.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A cooling system for an exhaust pipe of a vehicle comprising
an engine;
an exhaust discharging device connected to the engine;
a generator having
a housing;
a rotor mounted in the housing, and connected to and driven by the engine; and
a fan mounted in the housing, connected to the rotor and synchronously rotating with the rotor; and
a cooling guide device connected to the housing of the generator and having a guide tube having
a proximal end connected to the housing and communicating with the housing; and
a distal end corresponding to the exhaust discharging device;
wherein the fan forms an air current to blow the exhaust discharging device.

2. The cooling system as claimed in claim 1, wherein the housing of the generator has an outlet and an inlet.

3. The cooling system as claimed in claim 2, wherein the generator further has
an inlet pipe connected to the inlet of the housing and corresponding to the inlet of the housing; and
a wind collection cover connected to the inlet pipe and having an inlet.

4. The cooling system as claimed in claim 3, wherein the generator is disposed beside the engine; and
the inlet of the housing is disposed more distant from the engine than the outlet of the housing.

5. The cooling system as claimed in claim 4, wherein the guide tube is integral and curved.

6. The cooling system as claimed in claim 4, wherein the guide tube is an orthogonal elbow tube.

7. The cooling system as claimed in claim 1, wherein the fan of the generator has multiple blades radially arranged, and each blade is curved.

8. The cooling system as claimed in claim 2, wherein the fan of the generator has multiple blades radially arranged, and each blade is curved.

9. The cooling system as claimed in claim 3, wherein the fan of the generator has multiple blades radially arranged, and each blade is curved.

10. The cooling system as claimed in claim 4, wherein the fan of the generator has multiple blades radially arranged, and each blade is curved.

11. The cooling system as claimed in claim 5, wherein the fan of the generator has multiple blades radially arranged, and each blade is curved.

12. The cooling system as claimed in claim 6, wherein the fan of the generator has multiple blades radially arranged, and each blade is curved.
